(19) United States
(12) Patent Application Publication
(10) Pub. No.: US 2005/0269932 A1
(43) Pub. Date: Dec. 8, 2005

(54) Apparatus, device and method for emitting output light using group IIB element selenide-based phosphor material and/or thiogallate-based phosphor material

(76) Inventors: Kee Yean Ng, Penang (MY); Janet Bee Yin Chua, Perak (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/205,620

(22) Filed: Aug. 15, 2005

Related U.S. Application Data
(63) Continuation-in-part of application No. 10/920,496, filed on Aug. 17, 2004.
Application No. 10/920,496 is a continuation-in-part of application No. 10/761,763, filed on Jan. 21, 2004.

(51) Int. Cl. H05B 33/04; H05B 33/02; H05B 33/10

(52) U.S. Cl. 313/485; 313/486; 313/512; 445/25

(57) ABSTRACT

An apparatus, device and method for emitting output light utilizes Group IIB element Selenide-based phosphor material and/or Thiogallate-based phosphor material to convert at least some of the original light emitted from a light source of the device to different light to produce the output light, which may be white color light.

### REFERENCE TO RELATED APPLICATIONS

This application is a continuation-in-part of application Ser. No. 10/920,496, filed Aug. 17, 2004, which is a continuation-in-part of application Ser. No. 10/761,763, filed Jan. 21, 2004, for which priority is claimed. The entire prior applications are incorporated herein by reference.

### BACKGROUND OF THE INVENTION

Conventional light sources, such as incandescent, halogen and fluorescent lamps, have not been significantly improved in the past twenty years. However, light emitting diode (“LEDs”) have been improved to a point with respect to operating efficiency where LEDs are now replacing the conventional light sources in traditional monochrome lighting applications, such as traffic signal lights and automotive taillights. This is due in part to the fact that LEDs have many advantages over conventional light sources. These advantages include longer operating life, lower power consumption, and smaller size.

LEDs are typically monochromatic semiconductor light sources, and are currently available in various colors from UV-blue to green, yellow and red. Due to the narrow-band emission characteristics, monochromatic LEDs cannot be directly used for “white” light applications. Rather, the output light of a monochromatic LED must be mixed with other light of one or more different wavelengths to produce white light. Two common approaches for producing white light using monochromatic LEDs include (1) packaging individual red, green and blue LEDs together so that light emitted from these LEDs are combined to produce white light and (2) introducing fluorescent material into a UV, blue or green LED so that some of the original light emitted by the semiconductor die of the LED is converted into longer wavelength light and combined with the original UV, blue or green light to produce white light.

Between these two approaches for producing white light using monochromatic LEDs, the second approach is generally preferred over the first approach. In contrast to the second approach, the first approach requires a more complex driving circuitry since the red, green and blue LEDs include semiconductor dies that have different operating voltages requirements. In addition to having different operating voltage requirements, the red, green and blue LEDs degrade differently over their operating lifetime, which makes color control over an extended period difficult using the first approach. Moreover, since only a single type of monochromatic LED is needed for the second approach, a more compact device can be made using the second approach that is simpler in construction and lower in manufacturing cost. Furthermore, the second approach may result in broader light emission, which would translate into white output light having higher color-rendering characteristics.

A concern with the second approach for producing white light is that the fluorescent material currently used to convert the original UV, blue or green light results in LEDs having less than desirable luminance efficiency and/or light output stability over time.

In view of this concern, there is a need for an LED and method for emitting white output light using a fluorescent phosphor material with high luminance efficiency and good light output stability.

### SUMMARY OF THE INVENTION

An apparatus, device and method for emitting output light utilizes Group IIB element Selenide-based phosphor material and/or Thiogallate-based phosphor material to convert at least some of the original light emitted from a light source of the device to different light to produce the output light, which may be white color light.

A device for emitting output light in accordance with an embodiment of the invention includes a light source that emits first light having a chromaticity represented by a first chromaticity point in a chromaticity diagram and a wavelength-shifting region optically coupled to the light source to receive the first light. The wavelength-shifting region includes Group IIB element Selenide-based phosphor material having a property to convert some of the first light to second light having a chromaticity represented by a second chromaticity point in the chromaticity diagram. The wavelength-shifting region further includes Thiogallate-based phosphor material having a property to convert some of the first light to third light having a chromaticity represented by a third chromaticity point in the chromaticity diagram. The second light and the third light are components of the output light, which has a chromaticity represented by a chromaticity point in the chromaticity diagram bounded within a triangle defined by the first, second and third chromaticity points.

A method for emitting output light in accordance with an embodiment of the invention includes generating first light having a chromaticity represented by a first chromaticity point in a chromaticity diagram, receiving the first light, including converting some of the first light to second light having a chromaticity represented by a second chromaticity point in the chromaticity diagram using Group IIB element Selenide-based phosphor material and converting some of the first light to third light having a chromaticity represented by a third chromaticity point in the chromaticity diagram using Thiogallate-based phosphor material, and emitting at least the second light and the third light as components of the output light, which has a chromaticity represented by a chromaticity point in the chromaticity diagram bounded within a triangle defined by said first, second and third chromaticity points.

An apparatus for proving illumination in accordance with an embodiment of the invention comprises at least one light emitting device and a light transmitting panel. The light emitting device includes a light source that emits first light having a chromaticity represented by a first chromaticity point in a chromaticity diagram and a wavelength-shifting region optically coupled to the light source to receive the first light. The wavelength-shifting region includes Group IIB element Selenide-based phosphor material having a property to convert some of the first light to second light having a chromaticity represented by a second chromaticity point in the chromaticity diagram. The wavelength-shifting region further includes Thiogallate-based phosphor material having a property to convert some of the first light to third light having a chromaticity represented by a third chromaticity point in the chromaticity diagram. The second light and the third light are components of the output light, which has a chromaticity represented by a chromaticity point in the chromaticity diagram bounded within a triangle defined by the first, second and third chromaticity points. The light transmitting panel is optically coupled to the light emitting device to receive the output light. The light transmitting panel is configured to provide illumination using the output light.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a white phosphor-converted LED in accordance with an embodiment of the invention.

FIGS. 2A, 2B and 2C are diagrams of white phosphor-converted LEDs with alternative lamp configurations in accordance with an embodiment of the invention.

FIGS. 3A, 3B, 3C and 3D are diagrams of white phosphor-converted LEDs with a leadframe having a reflector cup in accordance with an alternative embodiment of the invention.

FIGS. 4A, 4B and 4C are diagrams of white phosphor-converted surface mount LEDs in accordance with different embodiments of the invention.

FIG. 5 shows the optical spectrum of a white phosphor-converted LED with a blue LED die in accordance with an embodiment of the invention.

FIG. 6 is a plot of luminance (lv) degradation over time for a white phosphor-converted LED in accordance with an embodiment of the invention.

FIG. 7 shows the Commission Internationale d'Eclairage (CIE) chromaticity diagram, illustrating chromaticity points that may be associated with different light generated by the LED of FIG. 1.

FIG. 8 is a diagram of an LCD backlighting apparatus in accordance with an embodiment of the invention.

FIG. 9 is a partial cross-sectional diagram of the backlighting apparatus of FIG. 8.

FIG. 10 is a diagram of an LCD backlighting apparatus in accordance with an alternative embodiment of the invention.

FIG. 11 is a diagram of a channel letter in accordance with an alternative embodiment of the invention

FIG. 12 is a flow diagram of a method for emitting output light in accordance with an embodiment of the invention.

### DETAILED DESCRIPTION

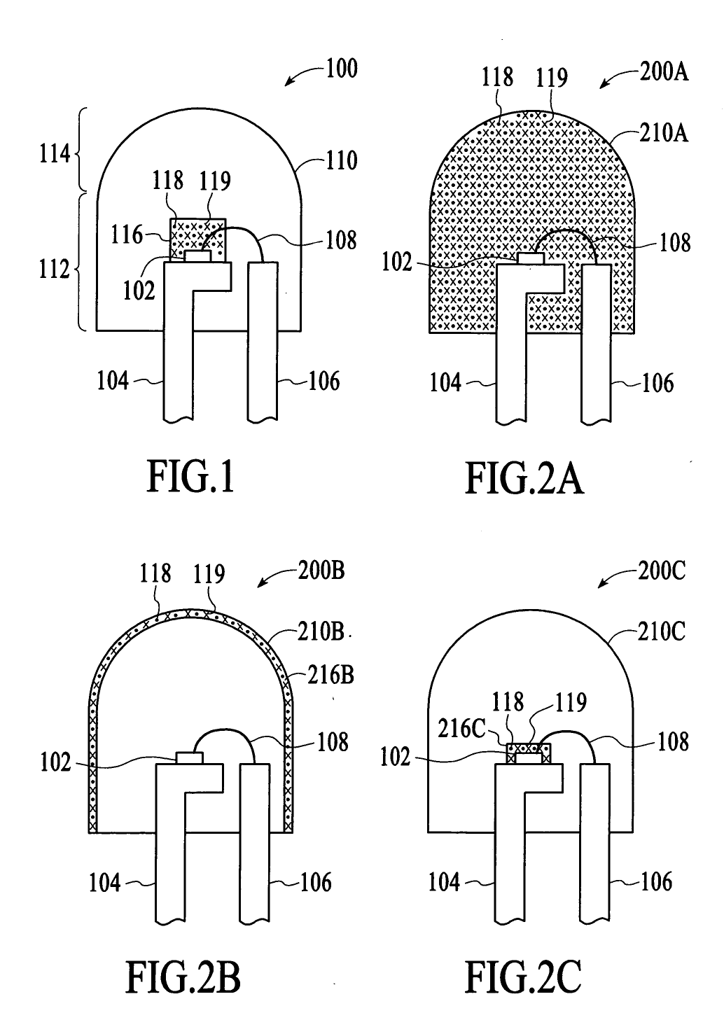

With reference to FIG. 1, a white phosphor-converted light emitting diode (LED) 100 in accordance with an embodiment of the invention is shown. The LED 100 is designed to produce “white” color output light with high luminance efficiency and good light output stability. The white output light is produced by converting some of the original light generated by the LED 100 into longer wavelength light using Group IIB element Selenide-based phosphor material and Thiogallate-based phosphor material.

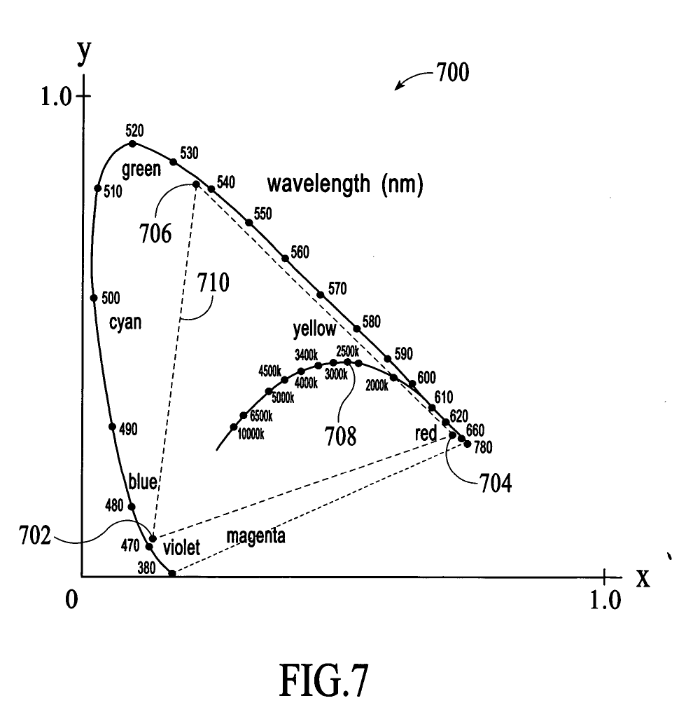

As shown in FIG. 1, the white phosphor-converted LED 100 is a leadframe-mounted LED. The LED 100 includes an LED die 102, leadframes 104 and 106, a wire 108 and a lamp 110. The LED die 102 is a semiconductor chip that generates light of a particular peak wavelength. Thus, the LED die 102 is a light source for the LED 100. In an exemplary embodiment, the LED die 102 is designed to generate light having a peak wavelength in the blue wavelength range of the visible spectrum, which is approximately 420 nm to 490 nm. This generated light has a chromaticity, which can be represented by a chromaticity point in the Commission Internationale d'Eclairage (CIE) chromaticity diagram. As shown in FIG. 7, the generated light may have a chromaticity represented by a chromaticity point 702 in the CIE chromaticity diagram 700, or any other chromaticity point in the CIE chromaticity diagram corresponding to light having a peak wavelength in the blue wavelength range. The LED die 102 is situated on the leadframe 104 and is electrically connected to the other leadframe 106 via the wire 108. The leadframes 104 and 106 provide the electrical power needed to drive the LED die 102. The LED die 102 is encapsulated in the lamp 110, which is a medium for the propagation of light from the LED die 102. The lamp 110 includes a main section 112 and an output section 114. In this embodiment, the output section 114 of the lamp 110 is dome-shaped to function as a lens. Thus, the light emitted from the LED 100 as output light is focused by the dome-shaped output section 114 of the lamp 110. However, in other embodiments, the output section 114 of the lamp 100 may be horizontally planar.

The lamp 110 of the white phosphor-converted LED 100 is made of a transparent substance, which can be any transparent material such as clear epoxy, so that light from the LED die 102 can travel through the lamp and be emitted out of the output section 114 of the lamp. In this embodiment, the lamp 110 includes a wavelength-shifting region 116, which is also a medium for propagating light, made of a mixture of the transparent substance and two types of fluorescent phosphor materials based on Group IIB element Selenium 118 and Thiogallate 119.

The Group IIB element Selenide-based phosphor material 118 and the Thiogallate-based phosphor material 119 are used to convert some of the original light emitted by the LED die 102 to lower energy (longer wavelength) light. The Group IIB element Selenide-based phosphor material 118 absorbs some of the original light of a first peak wavelength from the LED die 102, which excites the atoms of the Group IIB element Selenide-based phosphor material, and emits longer wavelength light of a second peak wavelength. In the exemplary embodiment, the Group IIB element Selenide-based phosphor material 118 has a property to convert some of the original light from the LED die 102 into light of a longer peak wavelength in the red wavelength range of the visible spectrum, which is approximately 620 nm to 800 nm. As shown in FIG. 7, this “red” converted light may have a chromaticity represented by a chromaticity point 704 in the CIE chart 700, or any other chromaticity point in the CIE chromaticity diagram corresponding to light having a peak wavelength in the red wavelength range.

Similarly, the Thiogallate-based phosphor material 119 absorbs some of the original light from the LED die 102, which excites the atoms of the Thiogallate-based phosphor material, and emits longer wavelength light of a third peak wavelength. In the exemplary embodiment, the Thiogallate-based phosphor material 119 has a property to convert some of the original light from the LED die 102 into light of a longer peak wavelength in the green wavelength range of the visible spectrum, which is approximately 490 nm to 575 nm. As shown in FIG. 7, this “green” converted light may have a chromaticity represented by a chromaticity point 706 in the CIE chart 700, or any other chromaticity point in the CIE chromaticity diagram corresponding to light having a peak wavelength in the green wavelength range.

Although the majority of “red” converted light and “green” converted light are derived from the original light emitted by the LED die 102, some of the “red” converted light may be derived from some of the “green” converted light and vice versa. Thus, the Group IIB element Selenide-based phosphor material 118 may further have a property to convert some of the “green” converted light into “red” converted light. Similarly, the Thiogallate-based phosphor material 119 may further have a property to convert some of the “red” converted light into “green” converted light.

The second and third peak wavelengths of the converted light are partly defined by the peak wavelength of the original light and the Group IIB element Selenide-based phosphor material 118 and the Thiogallate-based phosphor material 119. The unabsorbed original light from the LED die 102 and the converted light are combined to produce “white” color light, which is emitted from the light output section 114 of the lamp 110 as output light of the LED 100. As shown in FIG. 7, the “white” color output light has a chromaticity represented by a chromaticity point 708 in the CIE chromaticity diagram 700, which is bounded within a triangle 710 defined by the chromaticity points 702, 704 and 706, which represent the chromaticity of the original light from the LED die 102, the converted light using the Group IIB element Selenide-based phosphor material 118 and the converted light using the Thiogallate-based phosphor material 119, respectively. The chromaticity point for the output light may be located along the blackbody radiation locus 712 in the CIE chromaticity diagram 700 at a location corresponding to a color temperature in a range from 1,000 degrees Kelvin to infinity, such as the chromaticity point 708. Alternatively, the chromaticity point for the output light may not be located along the blackbody radiation locus 712 in the CIE chromaticity diagram 700, but within the triangle 710.

The chromaticity point for the output light depends on the amount of Group IIB element Selenide-based phosphor material 118 and Thiogallate-based phosphor material 119 used in the wavelength-shifting region 116. If more Group IIB element Selenide-based phosphor material 118 is used, then the chromaticity point for the output light will be closer to the point 704. Similarly, if more Thiogallate-based phosphor material 119 is used, then the chromaticity point for the output light will be closer to the point 706. Thus, the location of the chromaticity point for the output light can be controlled to be anywhere within the triangle 710, including the boundary of the triangle, by adjusting the amount of Group IIB element Selenide-based phosphor material 118 and Thiogallate-based phosphor material 119 used in the wavelength-shifting region 116.

In one embodiment, the Group IIB element Selenide-based phosphor material 118 included in the wavelength-shifting region 116 of the lamp 110 is phosphor made of Zinc Selenide (ZnSe) activated by one or more suitable dopants, such as Copper (Cu), Chlorine (Cl), Fluorine (F), Bromine (Br), Silver (Ag) and rare earth elements. In an exemplary embodiment, the Group IIB element Selenide-based phosphor material 118 is phosphor made of ZnSe activated by Cu, i.e., ZnSe:Cu. Unlike conventional fluorescent phosphor materials that are used for producing white color light using LEDs, such as those based on alumina, oxide, sulfide, phosphate and halophosphate, ZnSe:Cu phosphor is highly efficient with respect to the wavelength-shifting conversion of light emitted from an LED die. This is due to the fact that most conventional fluorescent phosphor materials have a large bandgap, which prevents the phosphor materials from efficiently absorbing and converting light, e.g., blue light, to longer wavelength light. In contrast, the ZnSe:Cu phosphor has a lower bandgap, which equates to a higher efficiency with respect to wavelength-shifting conversion via fluorescence.

In an alternative embodiment, the Group IIB element Selenide-based phosphor material 118 included in the wavelength-shifting region 116 of the lamp 110 is phosphor made of Cadmium Selenide, which may be activated by one or more suitable dopants. In another embodiment, the Group IIB element Selenide-based phosphor material 118 included in the wavelength-shifting region 116 of the lamp 110 is phosphor made of Zinc Selenium Sulfide (ZnSeS), which may be activated by one or more suitable dopants such as Cu, Cl, F, Br, Ag and rare earth elements.

The Thiogallate-based phosphor material 119 included in the wavelength-shifting region 116 of the lamp 110 may be a metal-Thiogallate-based phosphor material activated by one or more suitable dopants, such as rare earth elements. The metal-Thiogallate-based phosphor material may have a structure defined by MN_{z}S_{y}, where M is a Group IIA element, such as Barium (Ba), Calcium (Ca), Strontium (Sr) and Magnesium (Mg), N is a Group IIIA element, such as Aluminum (Al), Gallium (Ga) and Indium (In), and x and y are numbers, for example, x is equal to 2 and y is equal to 4, or x is equal to 4 and y is equal to 7. In one embodiment, the Thiogallate-based phosphor material 119 is a Group IIA element Gallium Sulfide-based phosphor material, where Group IIA element can be Ca, Sr and/or Ba. As an example, the Thiogallate-based phosphor material 119 may be phosphor made of Barium Gallium Sulfide activated by one or more suitable dopants, such as rare earth elements. Preferably, the Thiogallate-based phosphor material 119 is phosphor made of Barium Gallium Sulfide activated by Europium (Eu), i.e., BaGa₄S₇:Eu.

The preferred ZnSe:Cu phosphor can be synthesized by various techniques. One technique involves dry-milling a predefined amount of undoped ZnSe material into fine powders or crystals, which may be less than 5 μm. A small amount of Cu dopant is then added to a solution from the alcohol family, such as methanol, and ball-milled with the undoped ZnSe powders. The amount of Cu dopant added to the solution can be anywhere between a minimal amount to approximately six percent of the total weight of ZnSe material and Cu dopant. The doped material is then oven-dried at around one hundred degrees Celsius (100° C.), and the resulting cake is dry-milled again to produce small particles. The milled material is loaded into a crucible, such as a quartz crucible, and sintered in an inert atmosphere at around one thousand degrees Celsius (1,000° C.) for one to two hours. The sintered materials can then be sieved, if necessary, to produce ZnSe:Cu phosphor powders with desired particle size distribution, which may be in the micron range.

The ZnSe:Cu phosphor powders may be further processed to produce phosphor particles with a silica coating. Silica coating on phosphor particles reduces clustering or agglomeration of phosphor particles when the phosphor particles are mixed with a transparent substance to form a wavelength-shifting region in an LED, such as the wavelength-shifting region 116 of the lamp 110. Clustering or agglomeration of phosphor particles can result in an LED that produces output light having a non-uniform color distribution.

In order to apply a silica coating to the ZnSe:Cu phosphor particles, the sieved materials are subjected to an annealing process to anneal the phosphor particles and to remove contaminants. Next, the phosphor particles are mixed with silica powders, and then the mixture is heated in a furnace at approximately 200 degrees Celsius. The applied heat forms a thin silica coating on the phosphor particles. The amount of silica on the phosphor particles is approximately 1% with respect to the phosphor particles. The resulting ZnSe:Cu phosphor particles with silica coating may have a particle size of less than or equal to thirty (30) microns.

The preferred BaGa₄S₇:Eu phosphor can also be synthesized by various techniques. One technique involves using BaS and Ga₂S₃ as precursors. The precursors are ball-milled in a solution from the alcohol family, such as methanol, along with a small amount of Eu dopant, fluxes (Cl and F) and excess Sulfur. The amount of Eu dopant added to the solution can be anywhere between a minimal amount to approximately six percent of the total weight of all ingredients. The doped material is then dried and subsequently milled to produce fine particles. The milled particles are then loaded into a crucible, such as a quartz crucible, and sintered in an inert atmosphere at around eight hundred degrees Celsius (800° C.) for one to two hours. The sintered materials can then be sieved, if necessary, to produce BaGa₄S₇:Eu phosphor powders with desired particle size distribution, which may be in the micron range.

Similar to the ZnSe:Cu phosphor powders, the BaGa₄S₇:Eu phosphor powders may be further processed to produce phosphor particles with a silica coating. The resulting BaGa₄S₇:Eu phosphor particles with silica coating may have a particle size of less than or equal to forty (40) microns.

Following the completion of the ZnSe:Cu and BaGa₄S₇:Eu synthesis processes, the ZnSe:Cu and BaGa₄S₇:Eu phosphor powders can be mixed with the same transparent substance of the lamp 110, e.g., epoxy, and deposited around the LED die 102 to form the wavelength-shifting region 116 of the lamp. The ratio between the two different types of phosphor powders can be adjusted to produce different color characteristics for the white phosphor-converted LED 100. As an example, the ratio between the ZnSe:Cu phosphor powers and the BaGa₄S₇:Eu phosphor powders may be 1:5, respectively. The remaining part of the lamp 110 can be formed by depositing the transparent substance without the ZnSe:Cu and BaGa₄S₇:Eu phosphor powders to produce the LED 100. Although the wavelength-shifting region 116 of the lamp 110 is shown in FIG. 1 as being rectangular in shape, the wavelength-shifting region may be configured in other shapes, such as a hemisphere. Furthermore, in other embodiments, the wavelength-shifting region 116 may not be physically coupled to the LED die 102. Thus, in these embodiments, the wavelength-shifting region 116 may be positioned elsewhere within the lamp 110.

In FIGS. 2A, 2B and 2C, white phosphor-converted LEDs 200A, 200B and 200C with alternative lamp configurations in accordance with an embodiment of the invention are shown. The white phosphor-converted LED 200A of FIG. 2A includes a lamp 210A in which the entire lamp is a wavelength-shifting region. Thus, in this configuration, the entire lamp 210A is made of the mixture of the transparent substance and the Group IIB element Selenide-based and Thiogallate-based phosphor materials 118 and 119. The white phosphor-converted LED 200B of FIG. 2B includes a lamp 210B in which a wavelength-shifting region 216B is located at the outer surface of the lamp. Thus, in this configuration, the region of the lamp 210B without the Group IIB element Selenide-based and Thiogallate-based phosphor materials 118 and 119 is first formed over the LED die 102 and then the mixture of the transparent substance and the phosphor materials is deposited over this region to form the wavelength-shifting region 216B of the lamp. The white phosphor-converted LED 200C of FIG. 2C includes a lamp 210C in which a wavelength-shifting region 216C is a thin layer of the mixture of the transparent substance and the Group IIB element Selenide-based and Thiogallate-based phosphor materials 118 and 119 coated over the LED die 102. Thus, in this configuration, the LED die 102 is first coated or covered with the mixture of the transparent substance and the Group IIB element Selenide-based and Thiogallate-based phosphor materials 118 and 119 to form the wavelength-shifting region 216C and then the remaining part of the lamp 210C can be formed by depositing the transparent substance without the phosphor materials over the wavelength-shifting region. As an example, the thickness of the wavelength-shifting region 216C of the LED 200C can be between ten (10) and sixty (60) microns, depending on the color of the light generated by the LED die 102.

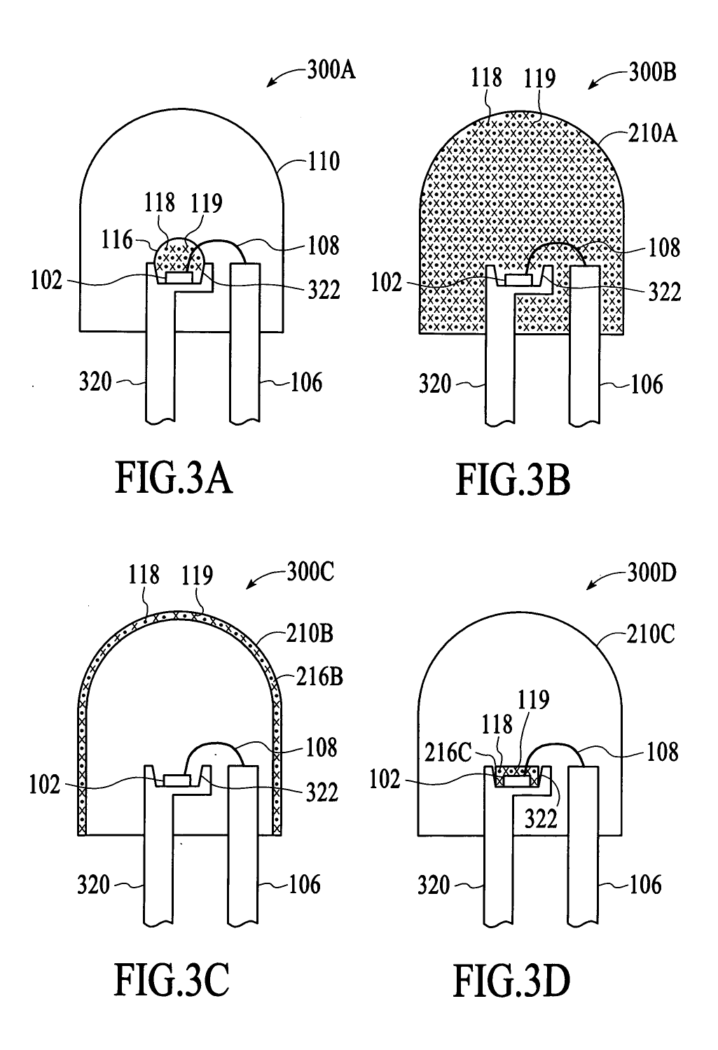

In an alternative embodiment, the leadframe of a white phosphor-converted LED on which the LED die is positioned may include a reflector cup, as illustrated in FIGS. 3A, 3B, 3C and 3D. FIGS. 3A-3D show white phosphor-converted LEDs 300A, 300B, 300C and 300D with different lamp configurations that include a leadframe 320 having a reflector cup 322. The reflector cup 322 provides a depressed region for the LED die 102 to be positioned so that some of the light generated by the LED die is reflected away from the leadframe 320 to be emitted from the respective LED as useful output light.

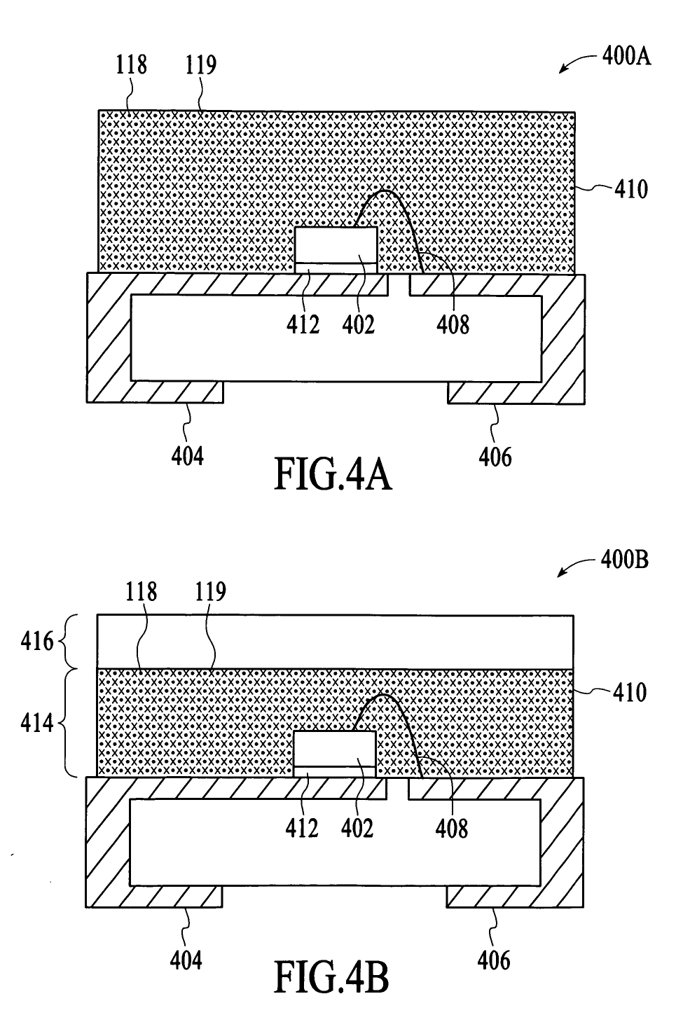

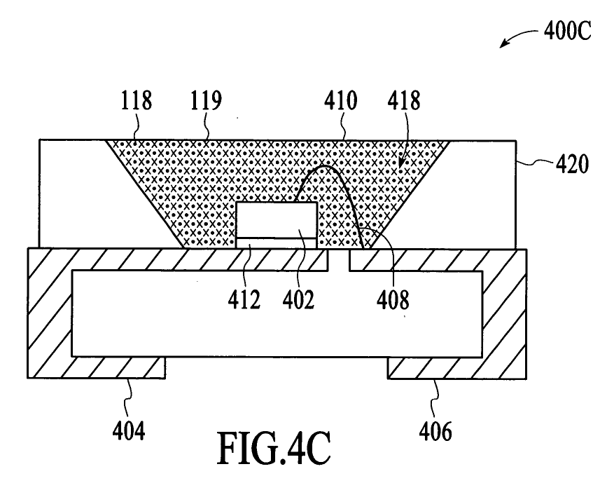

Turning now to FIG. 4A, a white phosphor-converted surface mount LED 400A in accordance with an embodiment of the invention is shown. The LED 400A includes an LED die 402, leadframes 404 and 406, a bond wire 408, and an encapsulant 410. The LED die 402 may be identical to the LED die 102 of the LED 100. The LED die 402 is attached to the leadframe 404 using an adhesive material 412. The bond wire 408 is connected to the LED die 402 and the leadframe 406 to provide an electrical connection. In this embodiment, the entire encapsulant 410 is a wavelength-shifting region, and thus, includes the Group IIB element Selenide-based phosphor material 118 and the Thiogallate-based phosphor material 119. However, in other embodiments, a portion of the encapsulant 410 may be a wavelength-shifting region, similar to the LEDs 100, 200A, 200B and 200C of FIGS. 1, 2A, 2B and 2C, respectively. As an example, as shown in FIG. 4B, the encapsulant 410 may comprise a wavelength-shifting region 414, which includes the Group IIB element Selenide-based phosphor material 118 and the Thiogallate-based phosphor material 119, and a clear region 416. The clear region 416 is positioned over the wavelength-shifting region 414. The clear region 416 may be made of an optically transparent material commonly used to form encapsulants in surface mount LEDs.

In FIG. 4C, a surface mount LED 400C in accordance with another embodiment of the invention is shown. The same reference numerals used in FIG. 4A are used to identify similar elements in FIG. 4C. In this embodiment, the LED 400C further includes a reflector cup 418 formed on a poly(p-phenyleneacetylene) (PPA) housing 420 on a printed circuit board. Again, in other embodiments, a portion of the encapsulant 410 may be a wavelength-shifting region, similar to the LEDs 100, 200A, 200B and 200C of FIGS. 1, 2A, 2B and 2C, respectively, or the LED 400A of FIG. 4B.

Although different embodiments of the invention have been described herein as being LEDs, other types of light emitting devices, such as semiconductor lasing devices, in accordance with the invention are possible. In these light emitting devices, other types of light sources may be used, rather than LED dies.

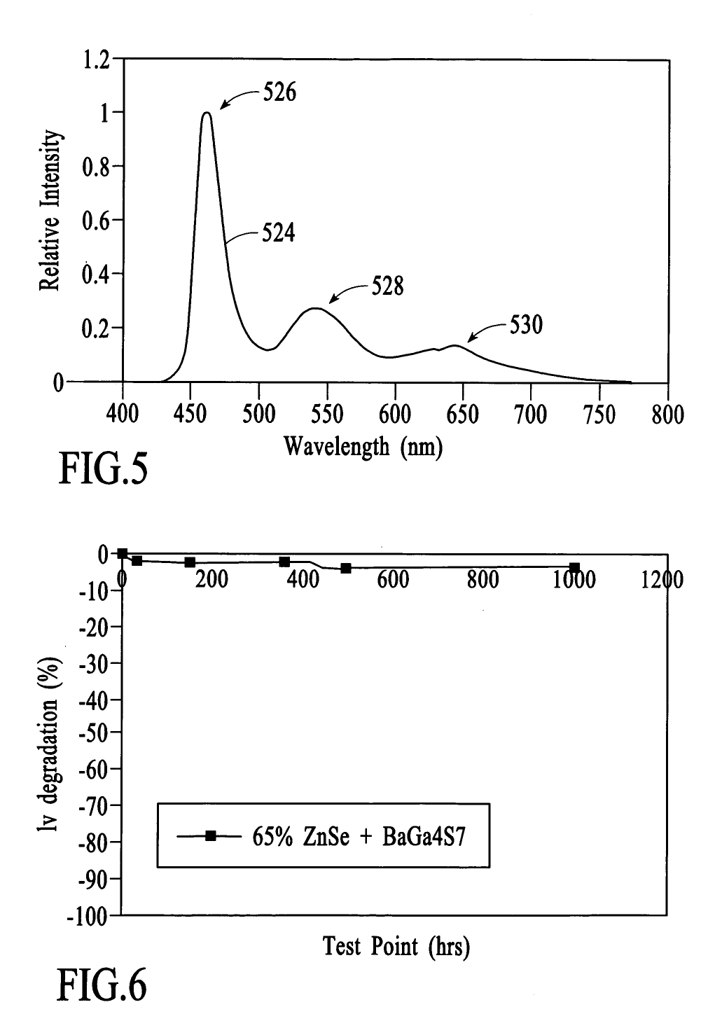

Turning now to FIG. 5, the optical spectrum 524 of a white phosphor-converted LED with a blue (440-480 nm) LED die in accordance with an embodiment of the invention is shown. The wavelength-shifting region for this LED was formed with twenty-five to thirty percent (25-30%) of ZnSe:Cu and BaGa₄S₇:Eu phosphors relative to epoxy. The percentage amount or loading content of ZnSe:Cu and BaGa₄S₇:Eu phosphors included in the wavelength-shifting region of the LED can be varied according to phosphor efficiency. As the phosphor efficiency is increased, e.g., by changing the amount of dopant(s), the loading content of the ZnSe:Cu and BaGa₄S₇:Eu phosphors may be reduced. The optical spectrum 524 includes a first peak wavelength 526 at around 460 nm, which corresponds to the peak wavelength of the light emitted from the blue LED die. The optical spectrum 524 also includes a second peak wavelength 528 at around 540 nm, which is the peak wavelength of the light converted by the BaGa₄S₇:Eu phosphor in the wavelength-shifting region of the LED, and a third peak wavelength 530 at around 645 nm, which is the peak wavelength of the light converted by the ZnSe:Cu phosphor in the wavelength-shifting regions of the LED.

FIG. 6 is a plot of luminance (lv) degradation over time for a white phosphor-converted LED having a wavelength-shifting region with sixty-five percent (65%) of ZnSe:Cu and BaGa₄S₇:Eu phosphors relative to epoxy in accordance with an embodiment of the invention. As illustrated by the plot of FIG. 6, the luminance properties of the white phosphor-converted LED experience little change over an extended period of time while being exposed to high intensity light, i.e., the light emitted from the semiconductor die of the LED. Thus, the ZnSe:Cu and BaGa₄S₇:Eu phosphors used in the LED have good resistance against light. This resistance to light is not limited to the light emitted from the semiconductor die of an LED, but also any external light, such as sunlight including ultraviolet light. Thus, LEDs in accordance with the invention are suitable for outdoor use, and can provide stable luminance over time with minimal color shift. In addition, these LEDs can be used in applications that require high response speeds since the duration of afterglow for the ZnSe:Cu and BaGa₄S₇:Eu phosphors is short.

The LEDs in accordance with different embodiments of the invention may be used as light source devices for a variety of lighting applications, for example, backlighting for an illuminated display device, such as a liquid crystal display (LCD) and a channel letter. As examples, two types of LCD backlight apparatus and a channel letter that use LEDs in accordance with different embodiments of the invention are now described.

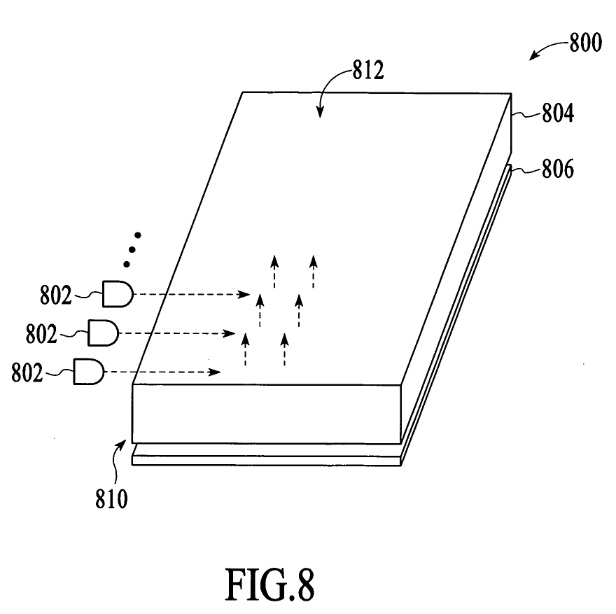

In FIG. 8, an LCD backlighting apparatus 800 in accordance with an embodiment of the invention is shown. The backlighting apparatus 800 includes a number of LEDs 802, a light panel 804 and a reflector 806. The LEDs 802 serve as light source devices for the backlighting apparatus 800. The LEDs 802 can be any type of LEDs in accordance with an embodiment of the invention. Although only three LEDs are shown in FIG. 8, the backlighting apparatus 800 may include any number of LEDs. As shown in FIG. 8, the LEDs 802 are positioned along a side 810 of the light panel 804. Thus, the output light from the LEDs 802 is transmitted into the light panel 804 through the side 810 of the light panel 804, which faces the LEDs. In other embodiments, the LEDs 802 may be positioned along more than one side of the light panel 804.

The light panel 804 serves to direct the LED light received at the side 810 of the light panel toward the upper surface 812 of the light panel so that illuminating light is emitted from the upper surface of the light panel in a substantially uniform manner. In an exemplary embodiment, the light panel 804 is a light guide panel (also known as “light pipe panel”). Thus, the light panel 804 will also be referred to herein as the light guide panel. However, in other embodiments, the light panel 804 may be any light transmitting panel that can emit illuminating light from a wide surface of the panel using light from one or more LEDs.

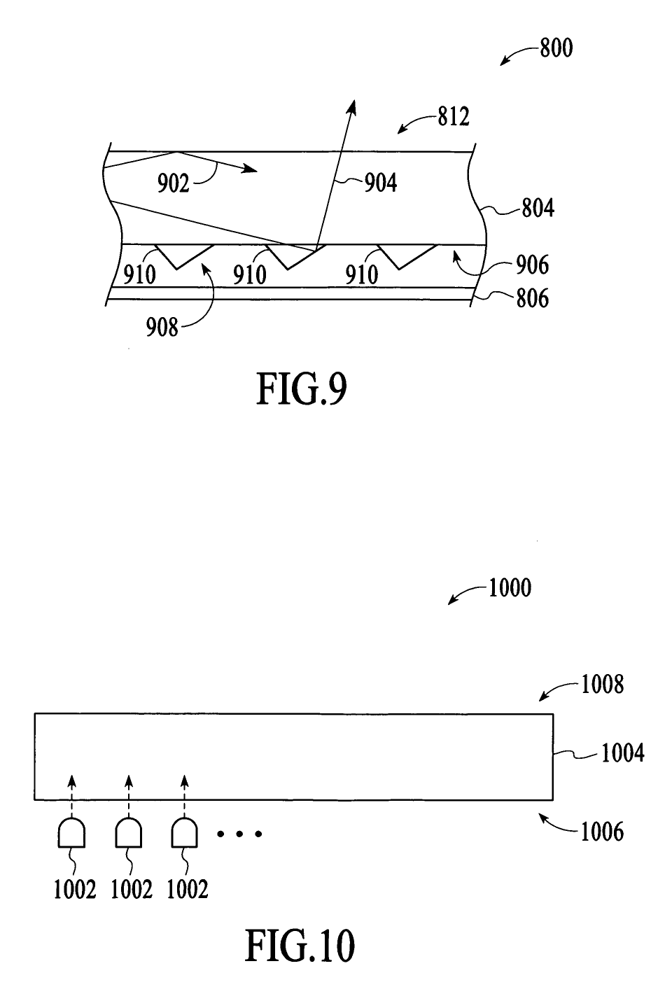

As illustrated in FIG. 9, the light guide panel 804 is designed such that light that is internally incident on the upper surface 812 of the light guide panel at large angles with respect to normal, as illustrated by the arrow 902, is internally reflected, while light that is internally incident on the upper surface at smaller angles, as illustrated by the arrow 904, is transmitted through the upper surface of the light guide panel. The light guide panel 804 may include a light extraction feature 908 to diffuse and scatter the light within the light guide panel so that light is emitted from the upper surface 812 of the light guide panel more uniformly. The light extraction feature 908 may be printed, chemical-etched or laser-etched dots on the bottom surface 906 of the light guide panel 804. Alternatively, the light extraction feature 908 may be a microstructured lens feature, as illustrated in FIG. 9, formed on the bottom surface 906 of the light guide panel 804. As shown in FIG. 9, the microstructured lens feature 908 includes many protrusions 910, which may have V-shaped cross-sectional profiles, that optimize angles of reflected or refracted light so that light can be extracted more uniformly from the upper surface 812 of the light guide panel 804.

As shown in both FIGS. 8 and 9, the reflector 806 is positioned below the light guide panel 804. The reflector 806 serves to reflect light emitted out of the bottom surface 906 of the light guide panel 804 back into the light guide panel so that the light may be emitted from the upper surface 812 of the light guide panel.

Turning now to FIG. 10, an LCD backlighting apparatus 1000 in accordance with an alternative embodiment of the invention is shown. Similar to the backlighting device 800 of FIG. 8, the backlighting apparatus 1000 includes a number of LEDs 1002 and a light panel 1004. However, in this embodiment, the LEDs 1002 are positioned below the lower surface 1006 of the light panel 1004, rather being positioned along a side of the light panel. Thus, light from the LEDs 1002 is transmitted into the lower surface 1006 of the light panel 1004 and emitted out of the upper surface 1008 of the light panel as illuminating light. The LEDs 1002 of the backlighting apparatus 1000 can be any type of LEDs in accordance with an embodiment of the invention. The light panel 1004 may be a light guide panel or any other light transmitting panel.

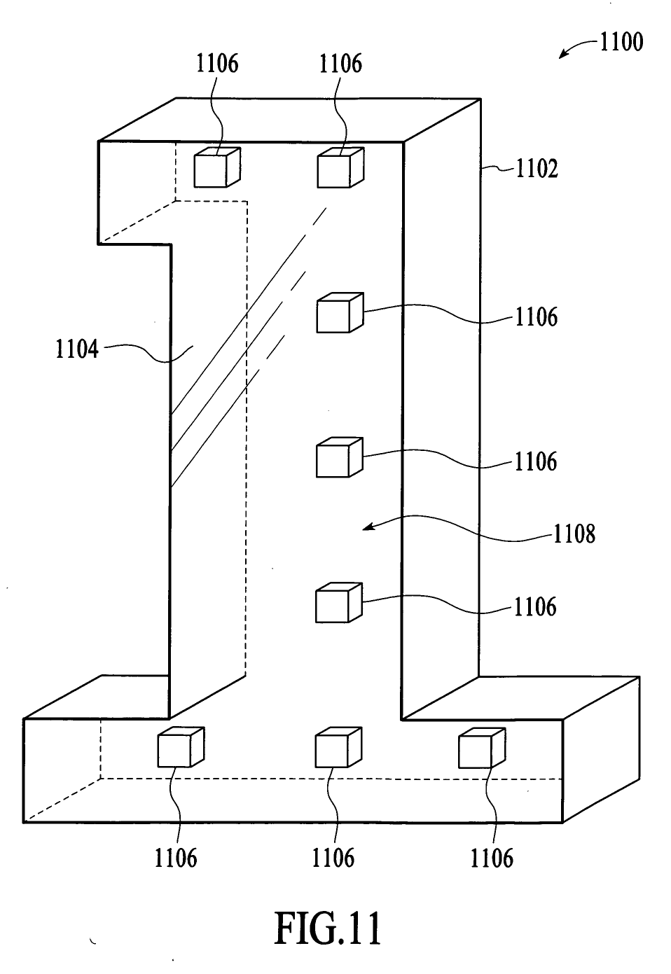

Turning now to FIG. 11, a channel letter 1100 in accordance with an embodiment of the invention is shown. As an example, the channel letter 1100 is illustrated in FIG. 11 as being configured as the number “1”. However, the channel letter 1100 may be configured as any letter or number. In fact, the channel letter 1100 may be configured as any symbol. The channel letter 1100 includes a housing 1102, a translucent panel 1104 and LEDs 1106. The housing 1102 is designed such that sides or “returns” conform to the outline of the desired symbol, which in this case is the number “1”. The sides of the housing 1102 form a channel 1108 in which the LEDs 1106 are located. The LEDs 1106 are attached the back of the housing 1102 within the channel 1108. The translucent panel 1104 is attached to sides of the housing 1102, covering the channel 1108 formed by the sides of housing. The translucent panel 1104 is shaped as the desired symbol, e.g., the number “1”. The translucent panel 1104 is made of a light transmitting material, such as acrylic or other polymer-based material. The translucent panel 1104 diffuses the light emitted from the LEDs 1106 to provide a uniform illumination in the shape of the desired symbol.

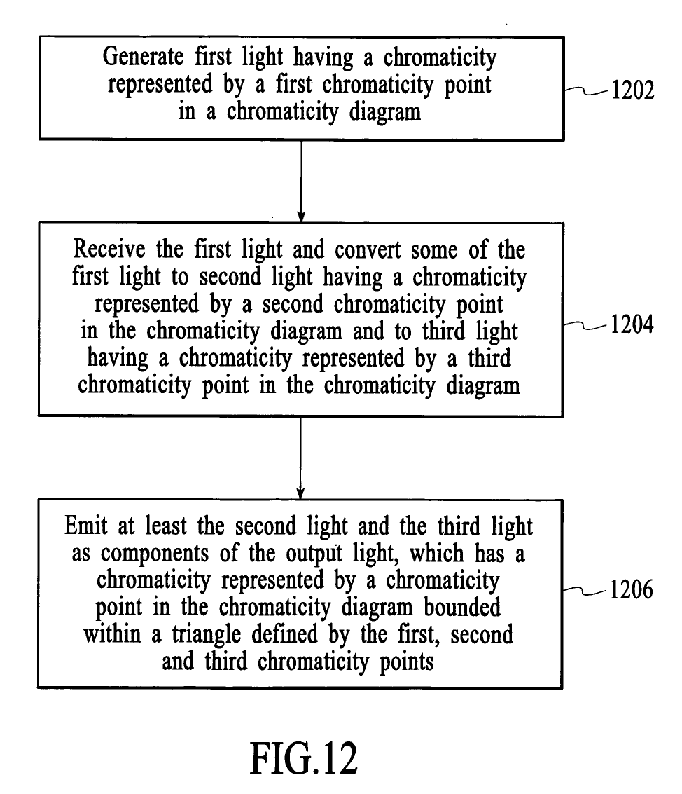

A method for emitting output light in accordance with an embodiment of the invention is described with reference to FIG. 12. At block 1202, first light having chromaticity represented by a first chromaticity point in a chromaticity diagram is generated. As an example, the chromaticity diagram may be the CIE chromaticity chart. The first light may be generated by an LED die, such as a UV or blue LED die. Next, at block 1204, the first light is received and some of the first light is converted to second light having chromaticity represented by a second chromaticity point in the chromaticity diagram using Group IIB element Selenide-based phosphor material. In addition, at block 1204, some of the first light is converted to third light having chromaticity represented by a third chromaticity point in the chromaticity diagram using Thiogallate-based phosphor material. Next, at block 1206, at least the second light and the third light are emitted as components of the output light. The output light has a chromaticity represented by a chromaticity point bounded within a triangle defined by the first, second and third chromaticity points in the chromaticity diagram.

Although specific embodiments of the invention have been described and illustrated, the invention is not to be limited to the specific forms or arrangements of parts so described and illustrated. Furthermore, the invention is not limited to devices and methods for producing white output lights. The invention also includes devices and methods for producing other types of output light. As an example, the Group IIB element Selenide-based phosphor material and/or the Thiogallate-based phosphor material in accordance with the invention may be used in a light emitting device where virtually all of the original light generated by a light source is converted to light of different wavelength, in which case the color of the output light may not be white. The scope of the invention is to be defined by the claims appended hereto and their equivalents.

1. A device for emitting output light, said device comprising:
a light source that emits first light having a chromaticity represented by a first chromaticity point in a chromaticity diagram; and
a wavelength-shifting region optically coupled to said light source to receive said first light, said wavelength-shifting region including Group IIB element Selenide-based phosphor material having a property to convert some of said first light to second light having a chromaticity represented by a second chromaticity point in said chromaticity diagram, said wavelength-shifting region further including Thiogallate-based phosphor material having a property to convert some of said first light to third light having a chromaticity represented by a third chromaticity point in said chromaticity diagram, said second light and said third light being components of said output light, said output light having a chromaticity represented by a chromaticity point bounded within a triangle defined by said first, second and third chromaticity points.

2. The device of claim 1 wherein said chromaticity point associated with said output light is located along the blackbody radiation locus in said chromaticity diagram.

3. The device of claim 2 wherein said chromaticity point associated with said output light is located along the blackbody radiation locus in said chromaticity diagram corresponding to a color temperature in a range from 1000 degrees Kelvin to infinity.

4. The device of claim 1 wherein said chromaticity point associated with said output light is not located along the blackbody radiation locus in said chromaticity diagram.

5. The device of claim 1 wherein said Group IIB element Selenide-based phosphor material further has a property to convert some of said third light to said second light and said Thiogallate-based phosphor material further has a property to convert some of said second light to said third light.

6. The device of claim 1 wherein said Group IIB element Selenide-based phosphor material of said wavelength-shifting region includes one of Zinc Selenide, Cadmium Selenide and Zinc Selenium Sulfide.

7. The device of claim 5 wherein said Group IIB element Selenide-based phosphor material includes said Zinc Selenide activated by at least one element selected from a group consisting of Copper, Chlorine, Fluorine, Bromine and Silver.

8. The device of claim 1 wherein said Thiogallate-based phosphor material has a structure defined by MNₓS_{y} where M is an element selected from a group consisting of Barium, Calcium, Strontium and Magnesium, N is an element selected from a group consisting of Aluminum, Gallium and Indium, and x and y are numbers.

9. The device of claim 8 wherein said Thiogallate-based phosphor material has a structure defined by one of MN₂S₄ and MN₄S₇.

10. The device of claim 1 wherein said Thiogallate-based phosphor material includes Barium Gallium Sulfide activated by a rare metal element.

11. The device of claim 10 wherein said Thiogallate-based phosphor material includes said Barium Gallium Sulfide activated by Europium as defined by the formula: BaGa₄S₇:Eu.

12. A method of emitting output light, said method comprising:
generating first light having a chromaticity represented by a first chromaticity point in a chromaticity diagram;
receiving said first light, including converting some of said first light to second light having a chromaticity represented by a second chromaticity point in said chromaticity diagram using Group IIB element Selenide-based phosphor material and converting some of said first light to third light having a chromaticity represented by a third chromaticity point in said chromaticity diagram using Thiogallate-based phosphor material; and
emitting at least said second light and said third light as components of said output light, said output light having a chromaticity represented by a chromaticity point in said chromaticity diagram bounded within a triangle defined by said first, second and third chromaticity points.

13. The method of claim 12 wherein said chromaticity point associated with said output light is located along the blackbody radiation locus in said chromaticity diagram.

14. The method of claim 13 wherein said chromaticity point associated with said output light is located along the blackbody radiation locus in said chromaticity diagram corresponding to a color temperature in a range from 1000 degrees Kelvin to infinity.

15. The method of claim 12 wherein said receiving includes converting some of said third light to said second light using said Group IIB element Selenide-based phosphor material and converting some of said second light to said third light using said Thiogallate-based phosphor material.

16. The method of claim 12 wherein said Group IIB element Selenide-based phosphor material includes one of Zinc Selenide, Cadmium Selenide and Zinc Selenium Sulfide.

17. The method of claim 12 wherein said Thiogallate-based phosphor material has a structure defined by MNₓS_{y}, where M is an element selected from a group consisting of Barium, Calcium, Strontium and Magnesium, N is an element selected from a group consisting of Aluminum, Gallium and Indium, and x and y are numbers.

18. The method of claim 17 wherein said Thiogallate-based phosphor material includes Barium Gallium Sulfide activated by a rare metal element.

19. An apparatus for proving illumination, said apparatus comprising:
at least one light emitting device, said light emitting device comprising:
a light source that emits first light having a chromaticity represented by a first chromaticity point in a chromaticity diagram; and
a wavelength-shifting region optically coupled to said light source to receive said first light, said wavelength-shifting region including Group IIB element Selenide-based phosphor material having a property to convert some of said first light to second light having a chromaticity represented by a second chromaticity point in said chromaticity diagram, said wavelength-shifting region further including Thiogallate-based phosphor material having a property to convert some of said first light to third light having a chromaticity represented by a third chromaticity point in said chromaticity diagram, said second light and said third light being components of said output light, said output light having a chromaticity represented by a chromaticity point in said chromaticity diagram bounded within a triangle defined by said first, second and third chromaticity points; and
a light transmitting panel optically coupled to said light emitting device to receive said output light, said light transmitting panel being configured to provide illumination using said output light.

20. The apparatus of claim 19 wherein said light transmitting panel is a light guide panel.

21. The apparatus of claim 19 wherein said light transmitting panel is a translucent panel having a shape of a symbol.

22. The apparatus of claim 19 wherein said Group IIB element Selenide-based phosphor material further has a property to convert some of said third light to said second light and said Thiogallate-based phosphor material further has a property to convert some of said second light to said third light.
